(19) United States
(12) Patent Application Publication
(10) Pub. No.: US 2026/0050468 A1
(43) Pub. Date: Feb. 19, 2026

(54) METHOD AND APPARATUS FOR SCHEDULING INFERENCE TASKS

(71) Applicant: OPT AI, CO., LTD., Ansan-si (KR)

(72) Inventors: Jae Ho LEE, Seoul (KR); Seong Wan KIM, Bucheon-si Gyeonggi-do (KR)

(21) Appl. No.: 19/369,861

(22) Filed: Oct. 27, 2025

Related U.S. Application Data
(63) Continuation of application No. PCT/KR2024/006661, filed on May 16, 2024.

(30) Foreign Application Priority Data
May 16, 2023 (KR) 10-2023-0062837
May 16, 2024 (KR) 10-2024-0063659

(51) Int. Cl. G06F 9/48; G06F 9/50

(52) U.S. Cl. CPC G06F 9/4843; G06F 9/5016; G06F 2209/503

(57) ABSTRACT

An embodiment relates to a method for scheduling an inference task performed by at least one processor. The method comprises: generating a memory resource list and a processing unit list for the inference task based on a configuration file, and creating task threads for the inference task based on the processing unit list; confirming a first required resource available from the memory resource list and a second required resource available from the processing unit list in response to a start request for the inference task, and receiving state information of the first required resource and the second required resource; and determining whether preset task conditions are satisfied in consideration of the state information of the first required resource and the second required resource, and performing the inference task or performing an alternative task for the inference task according to whether the task conditions are satisfied.

### CROSS-REFERENCE TO RELATED APPLICATION

This application is a continuation of PCT Patent Application No. PCT/KR2024/006661 filed on May 16, 2024, which claims priority to Korean Patent Application No. 10-2023-0062837, filed on May 16, 2023, and Korean Patent Application No. 10-2024-0063659, filed on May 16, 2024 in the Korean Intellectual Property Office, the disclosure of which is incorporated by reference herein in its entirety.

### BACKGROUND

### Technical Field

The present invention relates to a method and apparatus for scheduling inference tasks, and more particularly, to a method and apparatus for scheduling inference tasks by taking into account the state information of available resources.

### Background Field

As the expected performance of AI technology increases, the demand for simultaneously executing multiple AI models continues to grow. For example, in autonomous driving, it is necessary to recognize various types of objects such as lanes, traffic signals, pedestrians, and signs, and to control the vehicle accordingly. Since the requirements—such as response time and accuracy—can differ for each recognition task, separate AI models are generally constructed and executed periodically depending on the need.

To efficiently execute these multiple AI models, it is essential to implement an AI model orchestration algorithm that includes hardware resource management functions and scheduling functions for determining the execution timing and order of each model.

In industrial domains such as mobility, aviation, and defense—which require high levels of cognitive and decision-making capabilities as well as high reliability—more advanced software optimization is required compared to other domains. Due to the demand for highly reliable software, functional safety must be considered from the design phase.

Various technologies have been developed for executing multiple AI models on embedded devices. However, conventional technologies for running multiple AI models face significant limitations in terms of hardware and platform scalability, and fail to consider failure modes and effects analysis (FMEA).

Prior art 1 proposes a task distribution method in which a task is divided into multiple unit operations and each unit is processed separately. It describes a technique in which a requested task is split into multiple unit tasks, and the divided tasks are assigned to multiple cores to be processed in parallel.

However, Prior art 1 does not consider the availability or current state of resources such as memory or hardware components, and it also does not incorporate failure modes and effects analysis.

Accordingly, there is a need for a method of scheduling tasks while considering resource availability and failure modes and effects analysis.

### SUMMARY

To solve the above-mentioned technical problems, the present invention provides a scheduling method and apparatus that generate a list of memory resources and processing units suitable for inference tasks, receive state information of necessary resources among them, determine whether a preset target value is satisfied, and perform the inference task accordingly.

The technical problems to be solved by the present invention are not limited to the above-described examples, and other technical problems can be derived from the following description.

To solve the above-described technical problems, one embodiment of the present invention provides a method for scheduling inference tasks, the method being performed by at least one processor. The method for scheduling inference tasks includes: generating a memory resource list and a processing unit list for the inference task based on a configuration file; generating a task thread for the inference task based on the processing unit list; identifying a first required resource available from the memory resource list and a second required resource available from the processing unit list in response to a request to start the inference task; receiving state information of the first and second required resources; and determining whether preset task conditions are satisfied based on the state information of the first and second required resources, and performing the inference task or an alternative task based on whether the conditions are satisfied.

Another embodiment of the present invention provides an inference task scheduling apparatus. The apparatus includes: at least one processor; and a memory electrically connected to the processor and storing at least one code executable by the processor. The memory, when executed by the processor, causes the processor to: generate a memory resource list and a processing unit list for the inference task based on a configuration file; generate a task thread for the inference task based on the processing unit list; identify a first required resource available from the memory resource list and a second required resource available from the processing unit list in response to a request to start the inference task; receive state information of the first and second required resources; determine whether preset task conditions are satisfied based on the state information of the first and second required resources; and perform the inference task or an alternative task based on whether the conditions are satisfied.

According to the means for solving the problems described above, it is possible to execute various AI models efficiently without degrading response speed and while maintaining response accuracy.

In addition, the present invention allows highly reliable AI computation by making full use of limited hardware resources.

Moreover, it enables support for multiple AI models even in a heterogeneous hardware environment, thereby providing optimized performance through execution on various hardware platforms.

Furthermore, by predicting and managing Service Level Objective (SLO) violations, the system can be stabilized through automatic switching to alternative tasks upon failure.

The invention also enables optimal performance in accordance with real-time changing conditions by scheduling the execution of AI models.

Additionally, energy consumption can be minimized through efficient resource management.

Lastly, the invention allows equitable distribution of system resources in a multi-tenant environment while satisfying each user's requirements.

The effects of the present invention are not limited to those described above and include all effects understood from the following description.

### BRIEF DESCRIPTION OF THE DRAWINGS

FIG. 1 is a diagram illustrating an inference task scheduling apparatus according to an embodiment of the present invention.

FIG. 2 is a diagram illustrating a detailed configuration of another example of the inference task scheduling apparatus shown in FIG. 1.

FIG. 3 is a diagram illustrating an initialization operation and a task thread generation process, which are part of the operation of the inference task scheduling apparatus shown in FIGS. 1 and 2.

FIG. 4 is a diagram illustrating a resource state validation process and a resource data provision process, which are part of the operation of the inference task scheduling apparatus shown in FIGS. 1 and 2.

FIG. 5 is a diagram illustrating an inference execution process, which is part of the operation of the inference task scheduling apparatus shown in FIGS. 1 and 2.

FIG. 6 is a flowchart illustrating the procedure of an inference task scheduling method according to another embodiment of the present invention.

FIGS. 7 to 9 are flowcharts illustrating additional steps included in the inference task scheduling method shown in FIG. 6.

### DETAILED DESCRIPTION

Hereinafter, the present invention will be described in detail with reference to the accompanying drawings. However, the present invention is not limited to the embodiments described herein and may be implemented in various other forms. The drawings are provided merely to facilitate understanding of the embodiments of the invention, and the technical spirit of the invention is not limited by the drawings.

All technical and scientific terms used herein are to be interpreted in accordance with their ordinary meanings as understood by a person of ordinary skill in the art to which the invention pertains, unless otherwise defined. Predefined terms should also be interpreted as having meanings consistent with the related technical literature and the scope of the invention disclosed herein, and should not be construed in an overly idealized or limiting sense unless explicitly stated.

In order to clearly illustrate the invention, portions irrelevant to the description are omitted from the drawings. The size, shape, and configuration of each component shown in the drawings may be modified in various ways. Throughout the specification, identical or similar parts are labeled with the same or similar reference numerals.

The suffixes such as “unit,” “module,” and “means” used to describe components in the following description are provided only for ease of explanation and do not imply distinct meanings or roles. In describing the embodiments of the present invention, detailed descriptions of known technologies that may obscure the essence of the invention are omitted.

Throughout this specification, when one component is described as being “connected to” another component, this includes not only cases where they are “directly connected” (in contact, coupled, or linked), but also cases where they are “indirectly connected” through another component in between. Furthermore, when a component is described as “including” or “comprising” another component, it does not exclude the presence of additional components unless explicitly stated otherwise. The ordinal terms such as “first” and “second” used herein are merely for distinguishing between different elements and do not limit the sequence or relationship of the elements. For example, a “first component” may be referred to as a “second component,” and vice versa.

The singular forms used herein should be interpreted to include plural forms unless the context clearly dictates otherwise.

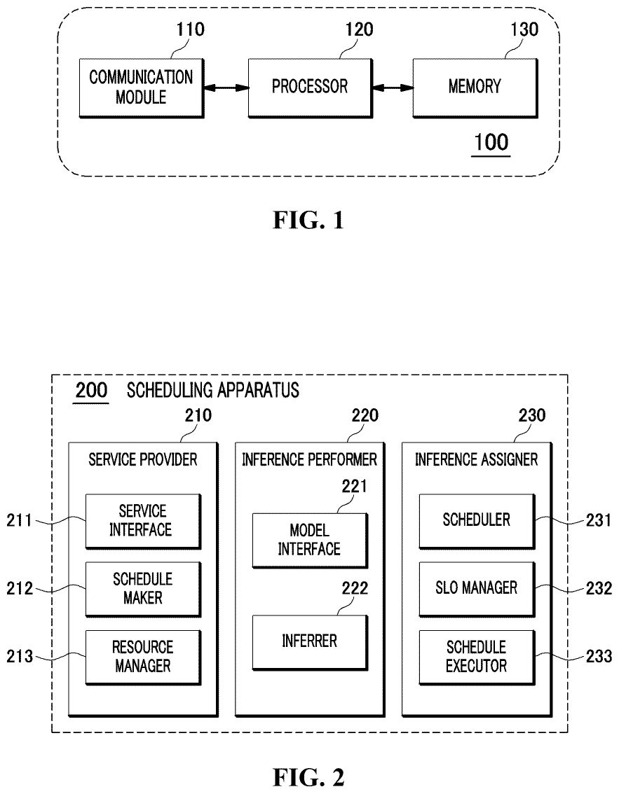

FIG. 1 is a diagram illustrating an inference task scheduling apparatus 100 according to an embodiment of the present invention.

Referring to FIG. 1, the scheduling apparatus (100) may include a communication module (110), a processor (120) configured to perform operations according to code stored in a memory (130), and the memory (130) storing the code.

The scheduling apparatus (100) may be implemented as a computer or a portable terminal capable of connecting to a server or another device via a network. The computer may include, for example, a notebook, desktop, or laptop equipped with a web browser. The portable terminal may include various types of wireless communication devices ensuring portability and mobility, such as smartphones, tablet PCs, or any type of handheld wireless communication device. Furthermore, the portable terminal may be an edge device or on-device AI equipped with at least one processor capable of performing AI model inference tasks. The network may include all types of wired networks such as a local area network (LAN), wide area network (WAN), or value added network (VAN), as well as all types of wireless networks such as a mobile radio communication network or a satellite communication network.

The communication module (110) may include hardware and software necessary for transmitting and receiving signals such as control signals or data signals through wired or wireless connections with other network devices. The communication module may transmit and receive wireless signals with at least one of a base station, an external terminal, or a server over a mobile communication network established based on communication standards or protocols used for mobile communication. Examples of such standards include, but are not limited to, Global System for Mobile Communication (GSM), Code Division Multiple Access (CDMA), CDMA2000, Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A).

The processor (120) may include various types of devices for controlling and processing data. The processor (120) may refer to a data processing device embedded in hardware that has physically structured circuits for performing functions represented by code or instructions included in a program. In one example, the processor (120) may be implemented as a microprocessor, a central processing unit (CPU), a processor core, a multiprocessor, an application-specific integrated circuit (ASIC), or a field programmable gate array (FPGA). However, the scope of the present invention is not limited thereto.

The memory (130) may store at least one or more of the following: information and data input via the communication module (110); information and data necessary for functions executed by the processor (120); and data generated by execution of the processor (120).

The memory (130) should be understood as a term collectively referring to non-volatile storage devices that retain stored information even when power is not supplied, and volatile storage devices that require power to maintain the stored information. In addition to volatile storage devices, the memory (130) may include cloud storage, solid-state drives (SSD), magnetic storage media, or flash storage media. However, the scope of the present invention is not limited thereto.

The memory (130) is electrically connected to the processor (120) and stores at least one code executed by the processor (120). The memory (130), when executed through the processor (120), stores code that causes the processor (120) to perform the following functions and procedures.

The memory (130) stores code that causes the processor (120) to generate a memory resource list and a processing unit list for the inference task based on a configuration file, and to generate a task thread for the inference task based on the processing unit list.

The memory (130) stores code that causes the processor (120) to, in response to a request to start the inference task, identify a first required resource available from the memory resource list and a second required resource available from the processing unit list, and receive state information of the first and second required resources.

The memory (130) stores code that causes the processor (120) to determine whether preset task conditions are satisfied based on the state information of the first and second required resources, and to perform the inference task or an alternative task based on the result of the determination.

The memory (130) may further store code that causes the processor (120) to perform an initialization process for the inference task based on the configuration file, prior to generating the memory resource list and processing unit list for the inference task and generating the task thread. The initialization process includes setting initial values for each of the different types of processing units available for the inference task.

The processing unit list may include a plurality of heterogeneous processing units, and the task threads may be generated separately for each of the heterogeneous processing units. The task conditions may include a first condition and a second condition. The first condition may include constraints related to the operation of the entire system, and each constraint may include a risk level, a constraint item, and a threshold value. The second condition may include constraints required for execution of each task model, and may include maximum delay time, memory usage, the number of recent consecutive executions, and the number of recent consecutive no-result occurrences.

The memory (130) may store code that causes the processor (120) to compare a preset importance level of the inference task with an expected risk level and determine whether the first condition is satisfied. The memory (130) may also store code that causes the processor (120) to compare the state information of the first and second required resources with the target information set for the inference task to determine whether the second condition is satisfied.

The risk level may be defined based on at least one of the expected temperature or current consumption of a specific area during execution of the inference task. The target information may include at least one of memory resource usage or the time required to complete execution of the inference task. If the importance level is equal to or less than the risk level, the memory (130) may store code that causes the processor (120) to determine that the inference task does not satisfy the first condition and to search for a preset first alternative task for the inference task.

The memory (130) may store code that causes the processor (120) to determine whether the searched first alternative task satisfies the first condition, and based on the determination result, to replace the inference task with the searched first alternative task or to perform error reporting. If the inference task satisfies the second condition, the memory (130) stores code that causes the processor (120) to perform the inference task. If the inference task does not satisfy the second condition, the memory (130) stores code that causes the processor (120) to search for a preset second alternative task for the inference task. The memory (130) may store code that causes the processor (120) to determine whether the searched second alternative task satisfies both the first and second conditions, and based on the result, to replace the inference task with the searched second alternative task or to perform error reporting.

FIG. 2 is a diagram illustrating a different example of the configuration of the scheduling apparatus according to an embodiment of the present invention. The scheduling apparatus (200) described below has substantially the same configuration as the scheduling apparatus (100) described with reference to FIG. 1. In other words, the operations and functions of the service provider (210), inference executor (220), and inference allocator (230) described below may be performed by the memory and processor shown in FIG. 1. Accordingly, repeated explanations will be omitted.

Referring to FIG. 2, the scheduling apparatus (200) may include the service provider (210), inference executor (220), and inference allocator (230).

The service provider (210) may read a configuration file, initialize the entire program, the inference executor (220), and the inference allocator (230), and return the inference result to the user upon receiving a user request. The configuration file may include global information, resource information, model information, and scheduling information.

The global information in the configuration file may include a complete model list, available hardware resources (e.g., NPU0, CPU0, CPU1, CPU, DSP0, etc.), and global SLO (Service Level Objective) constraints (e.g., CPU usage, memory usage, and power consumption, etc.).

The resource information in the configuration file may be a list of information on input and output data used by each model, and may include a resource main ID, resource name, resource data type, and resource data tensor format. Here, each model may include an importance level and an alternative model for SLO violation prediction.

If the importance level and alternative model are not set, the importance is set to 1, and the alternative model is set to error reporting. The importance level of error reporting is set to the maximum value that the system can have, and the resource consumption is set to “None,” such that the model is assumed never to cause an SLO violation under any circumstance.

The model information in the configuration file may include the model name, model backend type (name of the implementation for executing the model), expected execution time, path to the model binary file, model configuration parameters, individual model SLO information (e.g., delay limit and number of executions per second), name of the alternative model in case of SLO failure, list of input resource main IDs, rule for generating input resource sub IDs, list of output resource IDs, and rule for generating output resource sub IDs.

The scheduling information in the configuration file may include the name of the scheduling algorithm (e.g., static, PREMA, MAEL, DAIMOS, etc.), a default model execution list and execution conditions (e.g., model0: 30 fps, model1: 30 fps), and algorithm parameters.

The service provider (210) may include a service interface (211), a schedule maker (212), and a resource manager (213).

The service interface (211) may be communicatively connected to a user terminal (400) and other software modules. Through the communication connection, externally provided data may be registered for use in internal AI inference processes. Additionally, inference result values may be requested internally. If the result is not ready, the system may wait for a predefined timeout duration. Furthermore, inference execution may be manually triggered through a request, instead of waiting for the result automatically performed by the scheduler.

When the service interface (211) is connected to other software modules via communication, a common Message class may be used by all components. The Message class may include: a Message ID, indicating the type of message, a Sub ID, a unique identifier used to distinguish messages with the same ID, a type, representing a user-defined message category, and a datum, which is an array of actual data. Here, the datum may contain different content depending on the Message ID.

The resource manager (213) may perform new allocations for requested resources, register data received from external sources, return resources for unused data, determine availability and status of requested data resources, and deliver corresponding objects. The resource manager (213) may have management authority over all data received externally and all data generated internally. Upon receiving a request from another operator within the system or from a user, the resource manager (213) may transfer only the address of the corresponding data. To manage both statically allocated data and dynamically allocated data provided externally, the constructor and destructor of the data may be designated from outside. The policy for managing each data type may be determined based on information included in the configuration file.

The inference executor (220) may include a model interface (221) and an operation executor (222).

The model interface (221) operates with AI computing devices or operators having high computational power, and may perform computations using hardware accelerators or a CPU. In addition, hardware-optimized implementations may be separately provided as libraries, and each interface class may load such implementations based on configuration values read from the configuration file, or may call other internally implemented alternatives.

The operation executor (222) may perform computation based on a plurality of threads. Each individual thread may include an input/output queue and may use a priority queue or general queue data structure. Each thread may perform operations on a single hardware unit. For example, if multiple inference tasks can be processed in parallel via an internal queue within a single hardware unit, one operation executor may be configured as “NPU0-Primary” and another as “NPU0-Secondary.” When the scheduler determines that an inference task is executable, it may assign the task to the “NPU0-Secondary” operation executor. However, depending on the characteristics of the hardware, a single hardware unit may include two or more threads, and the scope of the present invention is not limited thereto.

Each thread of the operation executor (222) may read task information from the input queue, receive a model instance and a resource instance, perform inference, and return a result message to the output queue. Here, the task information may include: a task ID, a model ID to be used, a resource ID of related data, timing information (e.g., task start time), device ID used for execution, parameters required for execution, and profiling information generated during execution. If no task information exists in the input queue, the thread may enter a waiting state and recheck the input queue after a certain period of time. If the amount of task information in the input queue exceeds a threshold, the thread may refrain from performing inference, delete one entry from the input queue, and return an error message to the output queue.

The operation executor (222) may act on behalf of each hardware unit and be responsible for operations on the corresponding hardware. Depending on the characteristics of the scheduler, a single hardware unit may be used by two or more operation executors (222). For example, if multiple inferences can be performed in parallel via internal queues within a single hardware unit, one operation executor may be set as “NPU0-Primary” and the other as “NPU0-Secondary.” When the scheduler (231) determines that execution is feasible, it may assign the task to the NPU0-Secondary inferrer.

The operation executor (222) may repeat the following process: reading task information from its assigned queue (or priority queue), receiving model and resource instances, performing inference, and returning the resulting data instance to the output queue. If the input queue is empty, the thread is regarded as being in a wait state and may recheck the queue after a certain interval. If the input queue becomes excessively large, the thread may discard one piece of task information and deliver an error message to the output queue instead of performing inference.

The inference allocator (230) may include a scheduler (231), an SLO manager (232), and a schedule executor (233).

The scheduler (231) may determine, either dynamically or statically, the operation executor to be executed on each hardware unit at a given time based on data from the configuration file. In the case of static scheduling, the scheduler (231) may use initial configuration data by reading a sequence of data structures storing task information.

In the case of dynamic scheduling, it may read the scheduling algorithm and parameters and dynamically generate a list of task information.

Even after the task list is generated, if the SLO manager (232) requests alternative tasks, the task list may be updated accordingly. In such cases, depending on the hardware platform, a part or all of the scheduling algorithm may be delegated to the hardware. For example, an abstracted interface may be created for a SoC-dependent scheduler (not illustrated), and configuration values may be passed to the respective implementation so that the scheduling logic can be managed accordingly.

The SLO manager (232) may evaluate whether each task satisfies predefined constraints by predicting factors such as inference time, power consumption, memory usage, memory bandwidth consumption, and task success rate on the current hardware.

When an error is expected, the SLO manager (232) may propose an alternative task to replace the current one.

The SLO evaluation may be performed by the SLO manager (232) based on the following: execution history of the task, hardware temperature, hardware utilization, memory usage, and state of the input data. When the result of another task is likely to affect the SLO of the current task, the output of the other task may be used as the input to the current task.

The SLO manager (232) and scheduler (231) may be executed in the same thread in the form of function calls. If the SLO manager (232) determines that execution of a given task is not appropriate based on the SLO evaluation, it may cause an alternative service selector (not illustrated) to search for a suitable alternative task.

The alternative service selector may search for alternative tasks through the following process: If a task is expected to fail but must be executed unconditionally, the selector executes the task regardless. Afterward, it evaluates the degree of SLO constraint violation for subsequent tasks and initiates a new search for alternative tasks.

If an alternative task is preconfigured for SLO violation, the selector performs the alternative task and logs the execution history of the alternative task. If, based on the execution history, the alternative task can no longer be used, the selector may search for the next available alternative task. If the selector determines that continued execution is no longer possible (i.e., no valid alternative exists), it stops the search and re-evaluates the SLO violation degree, then restarts the process of searching for an alternative task.

Additionally, the selection of an alternative task in response to SLO (Service Level Objective) violation may be performed according to the following algorithm:

```
def SLO_Alternative_Selection(ModelID):
  prev_alternatives = set( )
  cur_model_id = ModelID
  while True:
  if cur_model_id in prev_alternatives:
    return cur_model_id
    prev_alternatives.insert(cur_model_id)
    current_warn_lev = 0
    for gc in global_constraints: # Check global constraints
      expected = get_resource(ModelID, gc.type)
      current = get_current_resource(gc.type)
      if gc.threshold < expected + current:
        current_warn_lev = max(current_warn_lev, gc.warn_lev)
    if cur_model_id.priority < current_warn lev:
      cur_model_id = cur_model_id.alternative
      continue
  if model_SLO_check(cur_model_id) == False:
      cur_model_id = cur_model_id.alternative
      continue
  return cur_model_id
```

A detailed explanation of the above algorithm is as follows. If the current task ID exists in the list of previously reviewed alternative tasks, it is determined that the current task ID must be forcibly executed, and the current task ID is returned. If it does not exist in the review list, the current task ID is added to the list of reviewed alternative tasks. Next, the current values for the global constraint conditions are retrieved. The global constraints may include hardware temperature, voltage, power consumption, CPU usage, and memory usage obtained from the device system.

The expected resource consumption that occurs when performing the task corresponding to the current task ID is predicted. The resource consumption prediction is calculated based on the results of the most recent N executions. The calculation may use constant values for computational efficiency, statistical methods, or prediction-based methods using ML algorithms. During prediction, different margins may be applied depending on the risk level of each constraint. The following table is an example case.

TABLE 1

| Category | Case 1 | Case 2 |
|---|---|---|
| Risk Level 1, 2 | Recent average | Predicted consumption |
| | value | value |
| Risk Level 3, 4 | Maximum within 66% | Predicted consumption × |
| | confidence interval | 1.1 |
| Risk Level 5+ | Maximum within 90% | Predicted consumption × |
| | confidence interval | 1.2 |

In the process of returning the current task ID, the predicted consumption value is calculated by adding the usage obtained from the task and the current values of the global constraints, and this is compared against the threshold of the global constraint.

$$g ( cond ) = cond . level * ( u ( c ( cond ) + e ( modelID , cond ) - cond . th )$$

In the above expression, cond.level refers to the predefined risk level of the global constraint, u(x) is the unit step function, c(cond) is the current system value for the constraint, and e(cond) is the predicted consumption value for the constraint when executing the current task.

The risk level of the current system is set to the highest risk level among the global constraints whose values exceed the threshold.

$${Lev}_{critical} = max ( g ( {cond}_{0} ) , … , g ( {cond}_{i} ) )$$

For example, in a system that uses the above constraints, if the current CPU temperature is 84.5° C. and the temperature increase estimated with a 66% confidence interval for the given task is between 0.4° C. and 1.0° C., the predicted post-execution temperature is calculated as 85.5° C., and the risk level is set to 3. In the same situation, if the current power consumption is 10 mA and the predicted increase is 0.1 mA, the risk level is elevated to 5.

If the importance level of the current model is lower than the system's current risk level—determined by the global constraints calculated in the preceding steps—the current model is considered to have violated the constraints. In this case, the alternative task ID is selected as the current task ID, and the process of adding the current task ID is repeated. Afterward, it is determined whether the current model violates the individual task constraints. For this evaluation, in Step 4, the risk level in the formula may be set as an arbitrary constant depending on the system. If a violation is found, the alternative task ID is selected again as the current task ID, and the process is repeated from Step 1. If the model is determined to be executable without any violations, the current task ID is returned.

The schedule executor (233) may read the next task determined by the scheduler (231) and deliver the task information to the input queue of the appropriate operation executor (222) within the inference executor (220) based on the task information values. In addition, to support the scheduler (231), it may receive data from the result queue of each operation executor (222) and update internal data accordingly.

Furthermore, to support the SLO manager (232), the schedule executor (233) may record and manage profiling information such as start time, end time, and hardware resource usage. The schedule executor (233) may communicate asynchronously with the operation executor (222) via a message queue in a single thread.

The schedule executor (233) may retrieve input tasks from the scheduler (231), deliver them to the appropriate device-level operation executor (222), and receive output data from each executor's result queue to update internal data for use by the scheduler (231). The communication with the operation executor may be handled asynchronously through a message queue, even within a single thread. Here, the scheduler (231), model loader (215), and SLO manager (232) may operate within the same thread in the form of function calls. The model loader (215) may be included in the service provider (210).

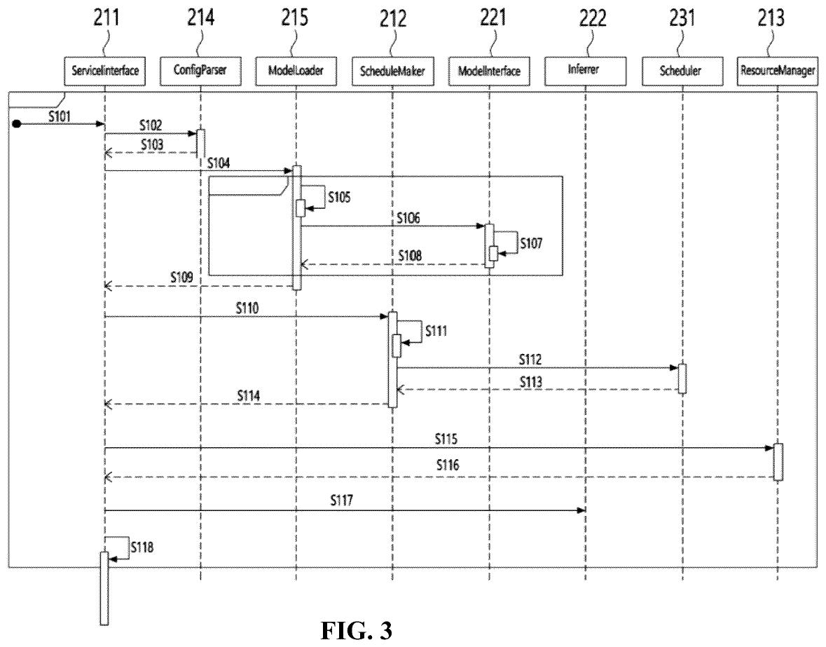

FIGS. 3 to 5 are diagrams illustrating in detail the operation of the scheduling apparatus (200) shown in FIG. 2.

The operations of the scheduling apparatus (200) described below may likewise be performed by the processor (120) and memory (130) of the scheduling apparatus (100).

FIG. 3 is a diagram illustrating in detail the initialization process and thread creation process during the operation of the scheduling apparatus (200) shown in FIG. 2.

The service interface (211) receives an initialization signal from the outside (S101). Here, the initialization signal may be in the form of a library function call. Thereafter, the service interface (211) reads the configuration file via other components such as a configuration analyzer (214) (S102).

The configuration analyzer (214) returns the parsed configuration file data to the service interface (211) (S103). The configuration analyzer (214) may be included in the service provider (210).

The service interface (211) delivers the configuration file data to the model loader (215) included in the inference executor, in order to initialize each model (S104).

The model loader (215) parses each model's information within the configuration file for individual model initialization (S105), and initializes the backend implementation to be used by the model interface (221) according to each backend type (S106).

The model interface (221) initializes the backend using the binary file path and parameter values specified in the model settings of the configuration file (S107).

The model interface (221) returns the initialized model instance to the model loader (215) (S108), and the model loader (215) returns the initialized model instance to the service interface (211) (S109). Thereafter, the schedule maker (212) is initialized (S110). (Steps S105 to S108 are similarly applied to the schedule maker initialization.)

The schedule maker (212) parses the scheduling parameters obtained from the configuration file (S111), and initializes the implementation of the scheduler (231) (S112). Here, during initialization, the scheduler (231) determines whether the parsed scheduling conditions are valid (S113). Based on the results obtained in S111 or S113, the schedule maker (212) returns an error code to the service interface (211) (S114).

The resource manager (213) generates a list of available resources based on the memory resource list from the configuration file data (S115), and after initialization, returns an error code to the service interface (211) (S116).

The operation executor (222) generates operation threads based on the list of available hardware resources in the configuration file (S117). Thereafter, the service interface (211) creates the main service task thread (S118).

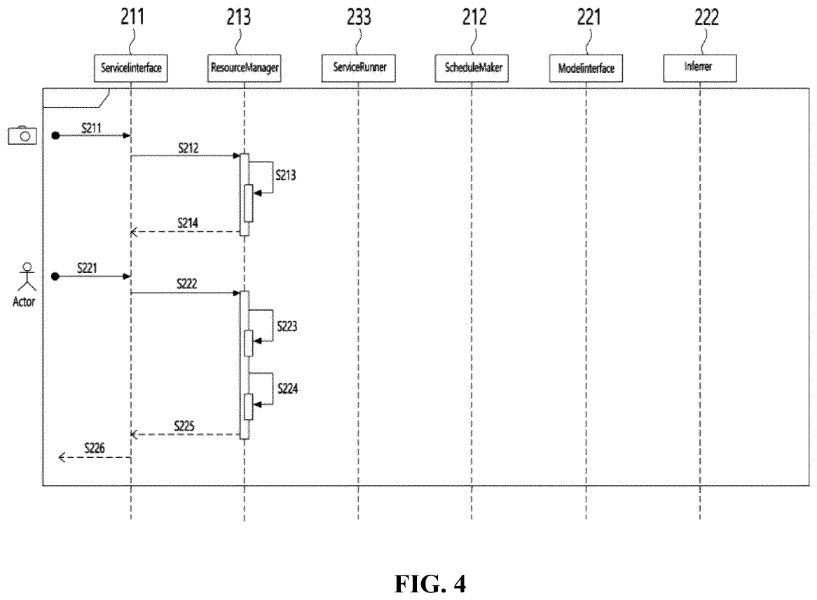

FIG. 4 is a diagram illustrating in detail the process of validating resource state and providing resource data during the operation of the scheduling apparatus (200) shown in FIG. 2.

Referring to FIG. 4, it includes: an internal processing phase based on external data reception and registration (Steps S211 to S214), and a return phase based on a data request from the user terminal (400) (Steps S221 to S226). Each of these phases may operate independently or simultaneously.

In FIG. 4: The service interface (211) receives a resource data value from an external source (S211) and calls the resource registration function of the resource manager (213) (S212).

The resource manager (213) validates the resource ID and resource data. If the data is determined to be valid, it stores the data internally (S213).

The resource manager (213) returns the resource ID and the validation result of the resource data to the service interface (211). Here, if the resource data is valid, it returns STATUS_OK; if there is an error, it returns a corresponding error status value (S214).

The service interface (211) receives a resource data request from the user terminal (400) (S221), and calls the resource data request function of the resource manager (213) (S222). The resource manager (213) checks the validity of the resource ID, Sub ID, and resource data. If valid, it generates the return data (S223). If the return data is not yet ready, the resource manager (213) waits for a predefined timeout period, and if the data becomes valid, it regenerates the return data (S224). The resource manager (213) returns the return data to the service interface (211). If the return data is not valid, it returns the previously stored error data to the service interface (211) (S225). The service interface (211) transmits the data received from the resource manager (213) to the user terminal (400) (S226).

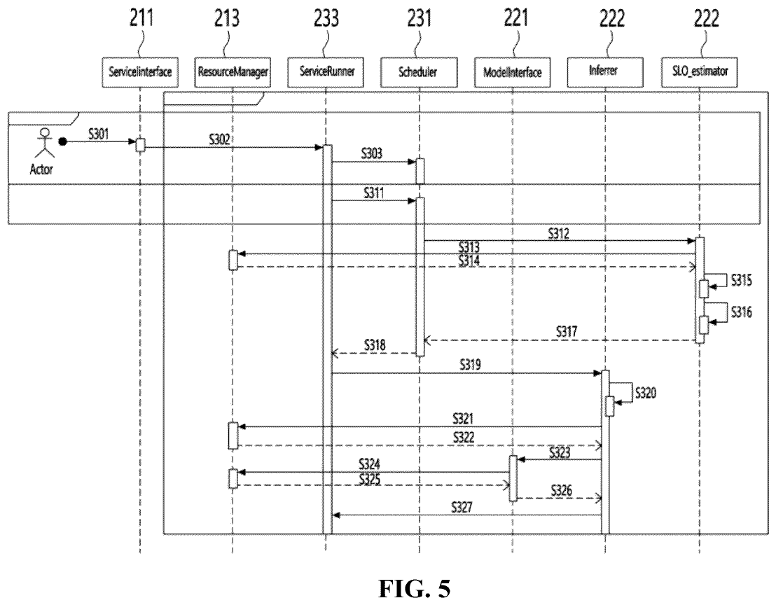

FIG. 5 is a diagram illustrating in detail the inference execution process during the operation of the scheduling apparatus (200) shown in FIG. 2.

Referring to FIG. 5, the inference process may include an explicit inference phase initiated by a user terminal (400) (Steps S301 to S303) and an automatic inference phase performed by the scheduler (231) (Steps S311 to S327). Each of these phases may operate independently or simultaneously.

The service interface (211) receives an explicit inference request from the user terminal (400) (S301) and transmits an inference request message to the schedule executor (233) (S302). The schedule executor (233) then requests an inference operation from the scheduler (231) (S303).

The schedule executor (233) sends the current timestamp to the scheduler (231) to request the inference task to be executed (S311).

The scheduler (231) requests the SLO manager (232) to evaluate whether the inference task can be performed without violating the SLO (S312).

The SLO manager (232) receives confirmation from the resource manager (213) regarding resource availability (S313) and receives the current state information of the required resources from the resource manager (213) (S314).

If the required resources are available, the SLO manager (232) determines whether the task can be executed without violating the SLO (S315). If it is determined that the task can be performed without SLO violation, the task is selected; otherwise, an alternative service selector (not illustrated) selects an alternative task. If an alternative task exists, Steps S312 through S315 are repeated to verify executability (S316).

The SLO manager (232) returns the final selected task information to the scheduler (231) (S317), and the scheduler (231) returns the final selected task information to the schedule executor (233) (S318).

If the final selected task information is valid, the schedule executor (233) requests the corresponding operation executor (222) to perform the task, and delivers the task to the appropriate thread of the operation executor (222) according to the device ID specified in the task information. If the task is not executable, the process returns to Step S312 after a predetermined time (S319).

The operation executor (222) interprets the received task information and initializes profiling information. Based on the device ID specified in the task information, the operation executor (222) identifies the instance of the model interface (221) and sets the relevant parameters (S320).

Then, the operation executor (222) requests the resource manager (213) to provide the resource data associated with the input ID information specified in the task (S321).

The resource manager (213) returns the resource data to the operation executor (222) (S322), and the operation executor (222) calls the inference execution function of the identified instance of the model interface (221) (S323).

The model interface (221) registers the inference result data with the resource manager (213) (S324), and the resource manager (213) verifies the registration result from the model interface (221) (S325). The model interface (221) returns an error code, including whether an error occurred during the inference process or resource registration, to the operation executor (222) (S326). The operation executor (222) delivers the error code along with a task completion code to the resource manager (213) (S327).

An example of the algorithm for the operation process of the scheduling apparatus (200) described with reference to FIGS. 2 to 5 will now be explained. The following program example corresponds to the preprocessing and postprocessing algorithms of a YOLO model for object detection and recognition services. Here, the configuration file data includes the following information:

“[Global]
num_model = 3
model = yolo_preprocess, yolo_model,yolo_model_alt, yolo_postprocess
num_hw = 2
hardwares = CPU0, NPU0
SLO_CPU_USAGE = 0.7
[Resources]
resource_ids = 101, 201, 202, 301
resource_101 = input_image, uint8_t, 3, 1280,720,3
resource_201 = preprocessed_image, uint8_t, 4, 1,3,640,640
resource_202 = yolo_inferenced, float32_t, 3, 1,25200, 85
resource_301 = object_lists, 100, 6
[yolo_preprocess]
backend = yolo_preprocessor # Implementation class name that inherits model_instance
estimated_time = 3.5 # milliseconds unit.
input_ids = 101
input_subid_type = incremental # timestamp, call_count, framecount, etc.
output_ids = 201
output_subid_type = same # timestamp, call_count, framecount, same, etc.
[yolo_model]
backend = tflite_coral
estimated_time = 10.4 # milliseconds unit.
model_binary = /var/data/yolo.tflite
SLO_types = time, fps
SLO_limits = 15, 30
SLO_alternative = yolo_model alt
input_ids = 201
input_subid_type = framecount# timestamp, call_count, framecount, etc.
output_ids = 202
output_subid_type = same # timestamp, call_count, framecount, same, etc.
[yolo_model_alt]
backend = tflite_cpu
estimated_time = 5.4 # milliseconds unit.
model_binary = /var/data/yolo_cpu.tflite
SLO_types = time, fps
SLO_limits = 15, 30
SLO_alternative = Error_report
input_ids = 201
input_subid_type = framecount # timestamp, call_count, framecount, etc.
output_ids = 202
output_subid_type = same # timestamp, call_count, framecount, same, etc.
[yolo_postprocess]
backend = yolo_postprocessor # Implementation class name that inherits model_instance
estimated_time = 5.5 # milliseconds unit.
model_parameter = 0.01, 0.35, 0.2
input_ids = 202
input_subid_type = framecount # timestamp, call_count, framecount, etc.
output_ids = 301
output_subid_type = same # timestamp, call_count, framecount, same, etc.
[scheduling]
algorithm = naive
yolo_preprocess = fps, 30
yolo_model = fps, 30, yolo_preprocess
yolo_postprocess = yolo_model”

This embodiment includes an initialization process and an inference execution process. The program is initialized based on the configuration file data. One instance of the Inferrer class is created for CPU0 and another for NPU0, respectively. Three model interface implementations are initialized: yolo_preprocess, yolo_model, yolo_model_alt, and yolo_postprocess. These respectively use CPU, NPU, CPU, and CPU, and such information is defined within each implementation. In addition, it is assumed that the scheduler uses a naive scheduler. This algorithm is assumed to execute sequentially in a round-robin manner. Input images are transmitted from the outside every 33 ms. The sub-ID of the input resource uses the frame count. Thereafter, result verification is requested externally immediately before the input image is delivered.

The inference execution process is performed by the thread of the schedule executor that requests inference tasks. According to the configuration of the configuration file, the first algorithm without dependencies, yolo_preprocess, is returned. Since yolo_preprocess has no SLO constraints, the SLO manager verifies only the validity of the input resources, and if the resources are valid, returns the task to be executed. Here, the input resource is valid if the sub-ID matches the frame count rule (subid=(subid_prev+1) % count max) for the ID value 101.

If the input resource is invalid, “no available task” is returned, and after a certain period of time the process is repeated starting from the step in which the thread of the schedule executor requests the next task. The schedule executor delivers task information to the CPU operation executor so that the task is performed by the operation executor. Since yolo_preprocess has been executed, the next task, yolo_model, is returned. Depending on the implementation of the scheduler algorithm, different results may be obtained, such as returning “no task” until preprocess is completed.

The process returns to the step in which yolo_model is returned until the input resource, namely the result of yolo_preprocess, becomes available. At the point when yolo_model becomes executable, an SLO prediction is performed. If it is executable, task information is delivered to the operation executor of NPU0. If there is a possibility of violation of either execution time or fps, it is verified whether yolo_model_alt can be executed on the CPU. If execution is not possible, Error report is performed. In the same manner as the previous process, yolo_postprocess is executed.

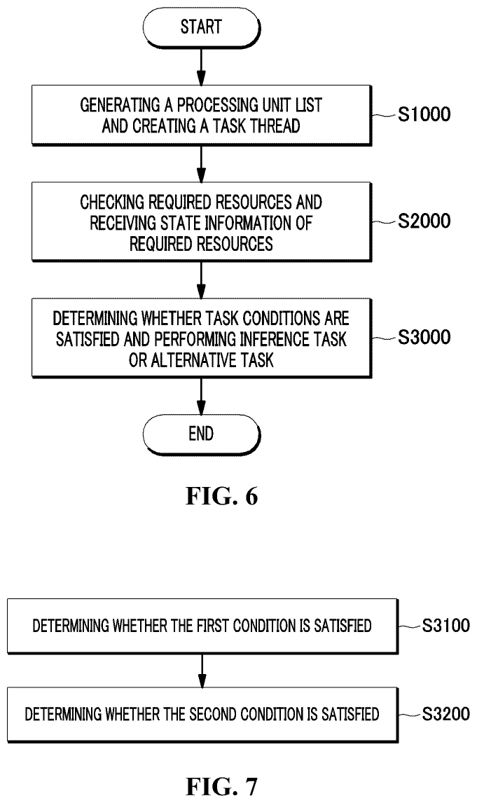

FIG. 6 is a flowchart illustrating the sequence of an inference task scheduling method according to another embodiment of the present invention, and FIGS. 7 to 9 are flowcharts illustrating additional steps included in the inference task scheduling method.

The inference task scheduling method (hereinafter referred to as the “scheduling method”) described with reference to FIGS. 6 to 9 may be performed by the scheduling apparatus (100) or the scheduling apparatus (200) as described above with reference to FIGS. 1 to 5. Accordingly, the embodiments of the present invention described with reference to FIGS. 1 to 5 may be equally applied to the embodiments described below, and duplicate descriptions with the foregoing explanation will be omitted. The steps described below are not necessarily performed in the stated order, and the sequence of the steps may be set in various ways, with some steps being performed substantially simultaneously.

Referring to FIG. 6, the scheduling method includes: a processing unit list generation and task thread creation step (S1000), a required resource confirmation and required resource state information receiving step (S2000), and a task condition satisfaction determination and inference task or alternative task execution step (S3000).

The processing unit list generation and task thread creation step (S1000) is a step of generating a memory resource list and a processing unit list for the inference task based on the configuration file, and creating task threads for the inference task based on the processing unit list. Here, the processing unit list may include a plurality of heterogeneous processing units, and the task threads may be generated for each of the heterogeneous processing units.

The required resource confirmation and required resource state information receiving step (S2000) is a step of confirming a first required resource available from the memory resource list and a second required resource available from the processing unit list in response to a start request for the inference task, and receiving the state information of the first required resource and the second required resource.

The task condition satisfaction determination and inference task or alternative task execution step (S3000) is a step of determining whether preset task conditions are satisfied in consideration of the state information of the first required resource and the second required resource, and performing the inference task or an alternative task for the inference task according to the determination. Here, the task conditions may include a first condition and a second condition.

Before the processing unit list generation and task thread creation step (S1000), the method may further include an initial task execution step for the inference task based on the configuration file. Here, the initial task may be setting an initial value for each of the different types of processing units available for the inference task.

Referring to FIG. 7, the task condition satisfaction determination and inference task or alternative task execution step (S3000) includes a first condition satisfaction determination step (S3100) and a second condition satisfaction determination step (S3200). The first condition satisfaction determination step (S3100) is a step of comparing the preset importance of the inference task with the risk level expected during execution of the inference task to determine whether the first condition is satisfied. Here, the risk level may be determined based on at least one of temperature and current consumption in a specific region expected during execution of the inference task.

The second condition satisfaction determination step (S3200) is a step of comparing the state information of the first required resource and the second required resource with target information set for the inference task to determine whether the second condition is satisfied. Here, the target information may include at least one of memory resource usage and time required to complete execution of the inference task.

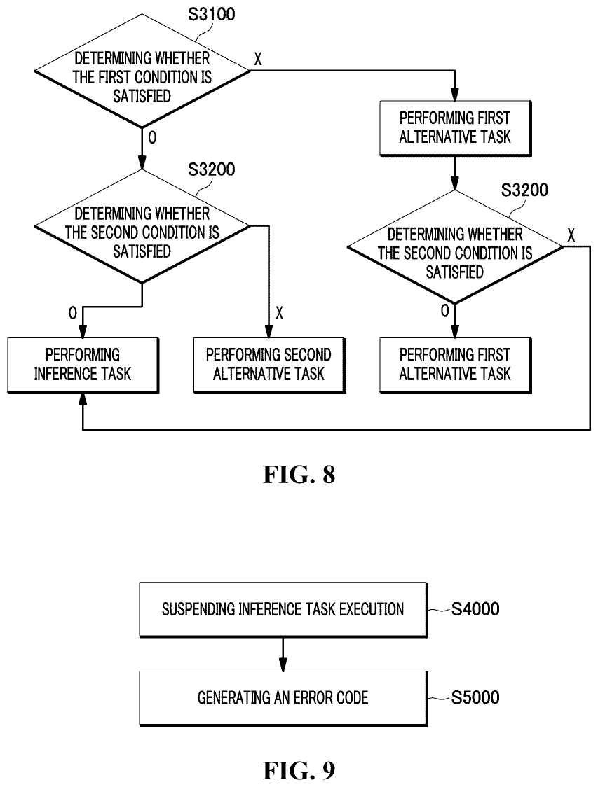

Referring to FIG. 8, the first condition satisfaction determination step (S3100) includes a first alternative task searching step (S3110) and a first alternative task substitution or error reporting step (S3120).

The first alternative task searching step (S3110) is a step of determining that the inference task does not satisfy the first condition when the importance is less than or equal to the risk level, and searching for a preset first alternative task for the inference task.

The first alternative task substitution or error reporting step (S3120) is a step of determining whether the searched first alternative task satisfies the first condition, and based on the determination result, substituting the searched first alternative task for the inference task, or performing error reporting.

The scheduling method of the embodiments of the present invention described above may also be implemented in the form of a computer-readable medium containing executable instructions such as program modules executed by a computer. The computer-readable medium may be any available medium accessible by a computer and includes both volatile and non-volatile media, as well as removable and non-removable media. In addition, the computer-readable medium may include a computer storage medium. The computer storage medium encompasses all volatile and non-volatile, removable and non-removable media implemented in any method or technology for storage of information such as computer-readable instructions, data structures, program modules, or other data.

Those skilled in the art to which the present invention pertains will understand that various modifications can be made in other specific forms without changing the technical spirit or essential characteristics of the invention based on the above description. Therefore, the embodiments described above should be understood to be illustrative in all respects and not restrictive. The scope of the present invention is defined by the following claims, and all modifications or variations derived from the meaning and scope of the claims and their equivalents should be construed as being included within the scope of the present invention. The scope of the present application is represented not by the foregoing detailed description but by the claims that follow, and all modifications or variations derived from the meaning and scope of the claims and their equivalents should be construed as being included within the scope of the present application.

### MODE FOR CARRYING OUT THE INVENTION

The mode for carrying out the invention is the same as the best mode for carrying out the invention described above.

### INDUSTRIAL APPLICABILITY

The present invention is a technology for generating a memory resource list and a processing unit list suitable for inference tasks, receiving state information of the required resources therefrom, and executing inference tasks after determining whether preset target values are satisfied. Since this can be applied to the AI industry, the invention has industrial applicability.

### DESCRIPTION OF REFERENCE NUMERALS

100: Inference task scheduling apparatus
110: Communication module
120: Processor
130: Memory
200: Inference task scheduling apparatus
210: Service provider
211: Service interface
212: Schedule maker
213: Resource manager
214: Configuration analyzer
215: Model loader
220: Inference executor
221: Model interface
222: Operation executor
230: Inference allocator
231: Scheduler
232: SLO manager
233: Schedule executor

What is claimed is:

1. A method for scheduling an inference task performed by at least one processor, the method comprising:
a) generating a memory resource list and a processing unit list for the inference task based on a configuration file, and creating a task thread for the inference task based on the processing unit list;
b) confirming a first required resource available from the memory resource list and a second required resource available from the processing unit list in response to a start request for the inference task, and receiving state information of the first required resource and the second required resource; and
c) determining whether preset task conditions are satisfied in consideration of the state information of the first required resource and the second required resource, and performing the inference task or performing an alternative task for the inference task according to whether the task conditions are satisfied.

2. The method of claim 1,
further comprising, before step a),
performing an initialization operation for the inference task based on the configuration file,
wherein the initialization operation is
setting an initial value for each of different types of processing units available for the inference task.

3. The method of claim 1,
wherein the processing unit list includes
a plurality of heterogeneous processing units, and
the task threads are generated
for each of the heterogeneous processing units.

4. The method of claim 1,
wherein the task conditions include
a first condition and a second condition, and
step c) comprises:
c-1) comparing the preset importance of the inference task with a risk level expected during execution of the inference task to determine whether the first condition is satisfied; and
c-2) comparing the state information of the first required resource and the second required resource with target information set for the inference task to determine whether the second condition is satisfied,
wherein the risk level is set based on at least one of temperature and current consumption in a specific region expected during execution of the inference task.

5. The method of claim 4,
wherein the target information includes
at least one of memory resource usage and time required to complete execution of the inference task.

6. The method of claim 4,
wherein step c-1) comprises:
determining that the inference task does not satisfy the first condition when the importance is less than or equal to the risk level, and searching for a preset first alternative task for the inference task; and
determining whether the searched first alternative task satisfies the first condition, and based on the determination result, substituting the searched first alternative task for the inference task or performing error reporting.

7. The method of claim 4,
wherein step c-2) comprises:
performing the inference task when the inference task satisfies the second condition, and searching for a preset second alternative task for the inference task when the inference task does not satisfy the second condition; and
determining whether the searched second alternative task satisfies the first condition and the second condition, and based on the determination result, substituting the searched second alternative task for the inference task or performing error reporting.

8. An inference task scheduling apparatus, comprising:
at least one processor; and
a memory electrically connected to the processor and storing at least one code executed by the processor,
wherein, when executed through the processor,
the memory stores code that causes the processor to generate a memory resource list and a processing unit list for the inference task based on a configuration file, create task threads for the inference task based on the processing unit list, confirm a first required resource available from the memory resource list and a second required resource available from the processing unit list in response to a start request for the inference task, receive state information of the first required resource and the second required resource, determine whether preset task conditions are satisfied in consideration of the state information of the first required resource and the second required resource, and perform the inference task or perform an alternative task for the inference task according to whether the task conditions are satisfied.

9. The apparatus of claim 8,
wherein the memory further stores code that causes the processor to perform an initialization operation for the inference task based on the configuration file before generating a memory resource list and a processing unit list for the inference task based on the configuration file and creating task threads for the inference task based on the processing unit list, and
wherein the initialization operation is
setting an initial value for each of different types of processing units available for the inference task.

10. The apparatus of claim 8,
wherein the processing unit list includes
a plurality of heterogeneous processing units, and
the task threads are generated
for each of the heterogeneous processing units.

11. The apparatus of claim 8,
wherein the task conditions include
a first condition and a second condition, and
the memory stores code that causes the processor to compare the preset importance of the inference task with a risk level expected during execution of the inference task to determine whether the first condition is satisfied; and
code that causes the processor to compare the state information of the first required resource and the second required resource with target information set for the inference task to determine whether the second condition is satisfied,
wherein the risk level is set based on at least one of temperature and current consumption in a specific region expected during execution of the inference task.

12. The apparatus of claim 11,
wherein the target information includes
at least one of memory resource usage and time required to complete execution of the inference task.

13. The apparatus of claim 11,
wherein the memory further stores code that causes the processor, when the importance is less than or equal to the risk level, to determine that the inference task does not satisfy the first condition and search for a preset first alternative task for the inference task; and
code that causes the processor to determine whether the searched first alternative task satisfies the first condition and, based on the determination result, substitute the searched first alternative task for the inference task or perform error reporting.

14. The apparatus of claim 11,
wherein the memory further stores code that causes the processor to perform the inference task when the inference task satisfies the second condition, and to search for a preset second alternative task for the inference task when the inference task does not satisfy the second condition; and
code that causes the processor to determine whether the searched second alternative task satisfies the first condition and the second condition and, based on the determination result, substitute the searched second alternative task for the inference task or perform error reporting.
